(19) United States
(12) Patent Application Publication
(10) Pub. No.: US 2016/0208868 A1
(43) Pub. Date: Jul. 21, 2016

(54) AUTOMATIC CLUTCH WITH MANUAL OVERRIDE

(71) Applicant: Paul Austin, Rochester, NY (US)

(72) Inventor: Paul Austin, Rochester, NY (US)

(21) Appl. No.: 15/003,458

(22) Filed: Jan. 21, 2016

Related U.S. Application Data
(60) Provisional application No. 62/106,022, filed on Jan. 21, 2015.

(51) Int. Cl. F16D 43/10

(52) U.S. Cl. CPC F16D 43/10

(57) ABSTRACT

Motorcycle and dirt bike centrifugal clutch assemblies that operate in automatic mode with manual override capability.

### BACKGROUND OF THE INVENTION

The present invention relates to clutch assemblies. More particularly, the invention relates to motorcycle and dirt bike clutch assemblies that operate in automatic mode with manual override capability.

Motorcycle and dirt bike clutches have been known for many years. Recent developments include automatic clutches including manual override. One such example is seen in U.S. Pat. No. 8,464,853 issued Jun. 18, 2013 to Rekluse Motorsports, Inc. While the Rekluse '853 patent provides a variety of alternate embodiments that provide an automatic clutch with manual override, there remains a need for a clutch that does not require removal of the clutch cover from the clutch to make adjustments to the clutch. There is yet a further need for a centrifugal auto-clutch that does not require manual clutch lever force against the centrifugal pressure plate to obtain manual clutch override.

### SUMMARY OF THE INVENTION

The present invention provides in one embodiment an automatic clutch assembly with manual override including a clutch basket to which is mounted a pressure plate with a plurality of balls captured therebetween. The balls are each individually retained in a respective oblong recess formed in the pressure plate with each recess having a substantially planar bottom surface. The clutch basket includes a bottom wall with a plurality of spaced walls extending perpendicularly therefrom. An inclined surface is formed in the bottom wall radially inwardly of and adjacent to the spaced walls. The recesses of the pressure plate are positioned in facing relation to the inclined surface of the clutch basket with the balls captured therebetween. At high RPMs, the balls are forced radially outwardly and travel within their respective oblong recesses along the inclined surface of the clutch basket. Due to the narrowing angle caused by the inclined surface, the balls apply a force against the pressure plate which then moves in a direction away from the clutch basket. This movement of the pressure plate causes compression of the clutch plate stack which is normally restrained by an outer pressure plate that acts as a stop against which the stack is pressed by the inner pressure plate during high RPMs. A rider may decide to manually override the clutch by pressing the clutch lever which raises the outer pressure plate away from the clutch plate stack.

An access hole is provided in the clutch cover which may be quickly removed to reveal the clutch adjustment screw which is threaded the outer pressure plate and may be rotated to move it and the push rod thrust bearing to which it is attached. The push rod thrust bearing may be moved to adjust the position of its engagement with the push rod as desired to set the clutch with the desired engagement/disengagement point of the outer pressure plate.

### DESCRIPTION OF THE DRAWING FIGURES

The above-mentioned and other features and advantages of this invention, and the manner of attaining them, will become apparent and be better understood by reference to the following description of the invention in conjunction with the accompanying drawing, wherein:

FIG. 1A is a cross-sectional view of an embodiment of the inventive clutch assembly;

FIG. 1B is an exploded perspective view of the clutch assembly of FIG. 1A;

FIG. 1C is an enlarged view of the lower left section of the clutch assembly of FIG. 1A;

FIG. 1D is an enlarged perspective view of a screw and spring used to secure the clutch basket to the inner pressure plate;

FIG. 1E is an enlarged side view of an embodiment of transmission shaft used with the present invention;

FIG. 1F is a fragmented, cross sectional view of the push rod end arrangement and engagement with the clutch adjustment screw and bearing of the outer pressure plate;

FIGS. 2A-C are top plan, bottom plan and perspective views of an embodiment of the clutch basket of the clutch assembly, respectively;

FIG. 3A-E are bottom perspective, top perspective, bottom plan, side elevation, and top plan views of an embodiment of the inner pressure plate of the clutch assembly, respectively;

FIG. 4 is a plan view of an embodiment of a fiber plate component of the clutch assembly;

FIG. 5 is a plan view of an embodiment of a smooth plate component of the clutch assembly;

FIGS. 6A-C are top plan, bottom perspective and top perspective views, respectively, of an embodiment of an inner gear component of the clutch assembly; and

FIGS. 7A-D are top plan, bottom plan, bottom perspective and top perspective views, respectively, of an embodiment of the outer pressure plate component of the clutch assembly.

### DETAILED DESCRIPTION OF A PREFERRED EMBODIMENT

One preferred embodiment of a clutch assembly according to the invention will now be described with reference to the drawing figures with descriptions of the main components followed by discussion of the clutch components assembly and clutch operation.

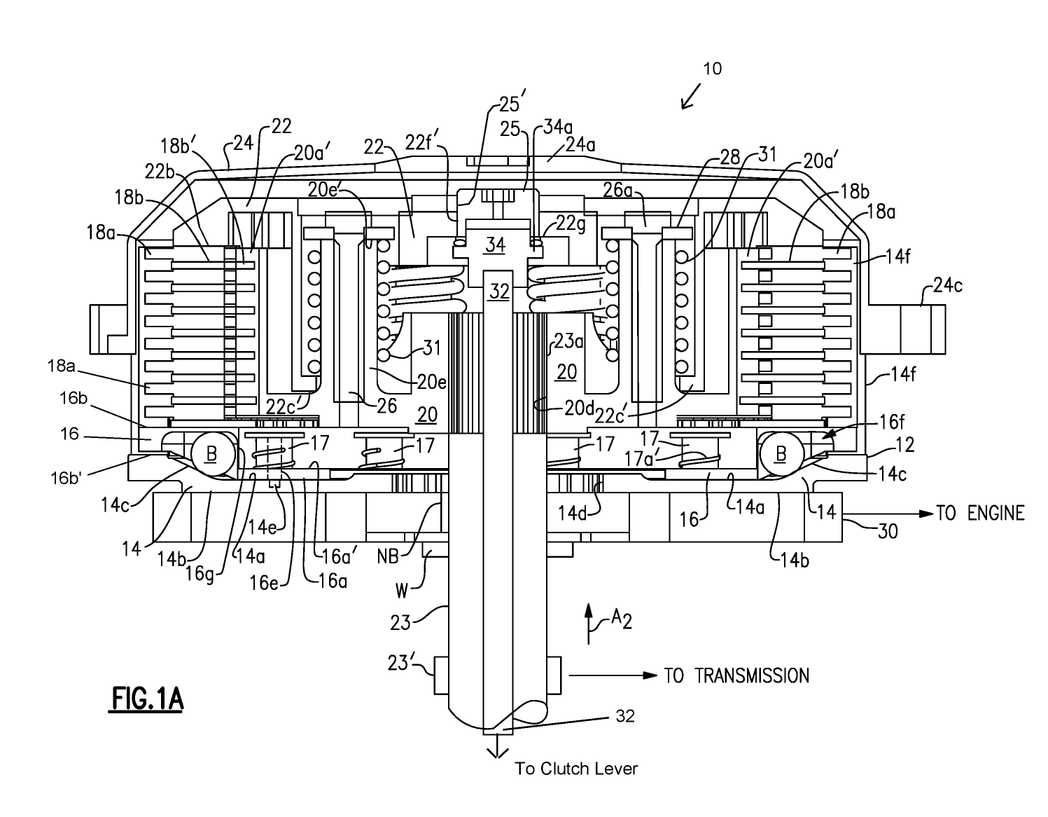

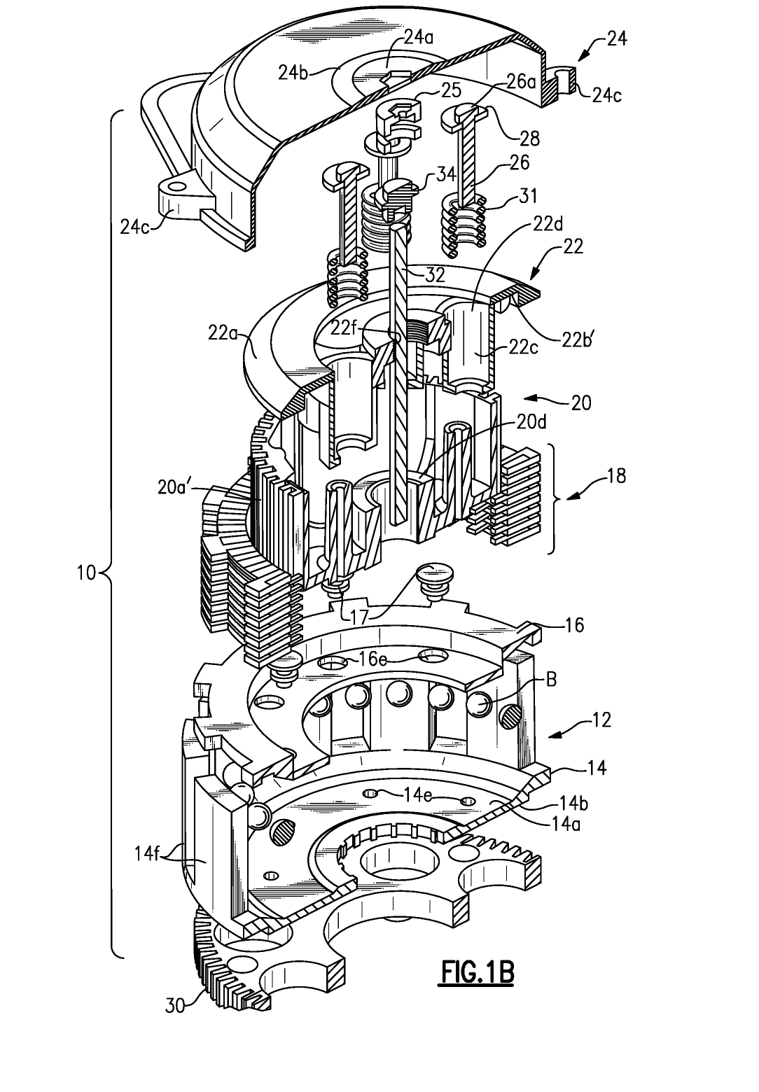

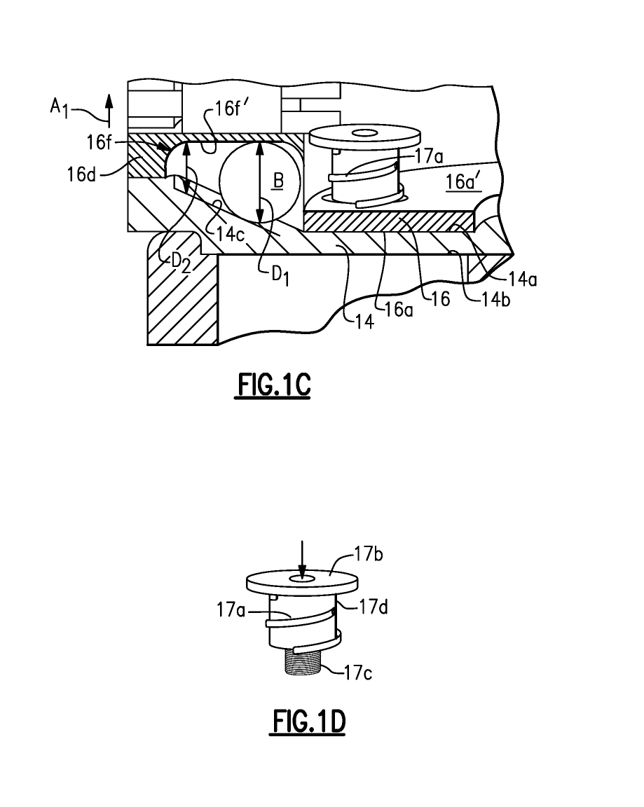

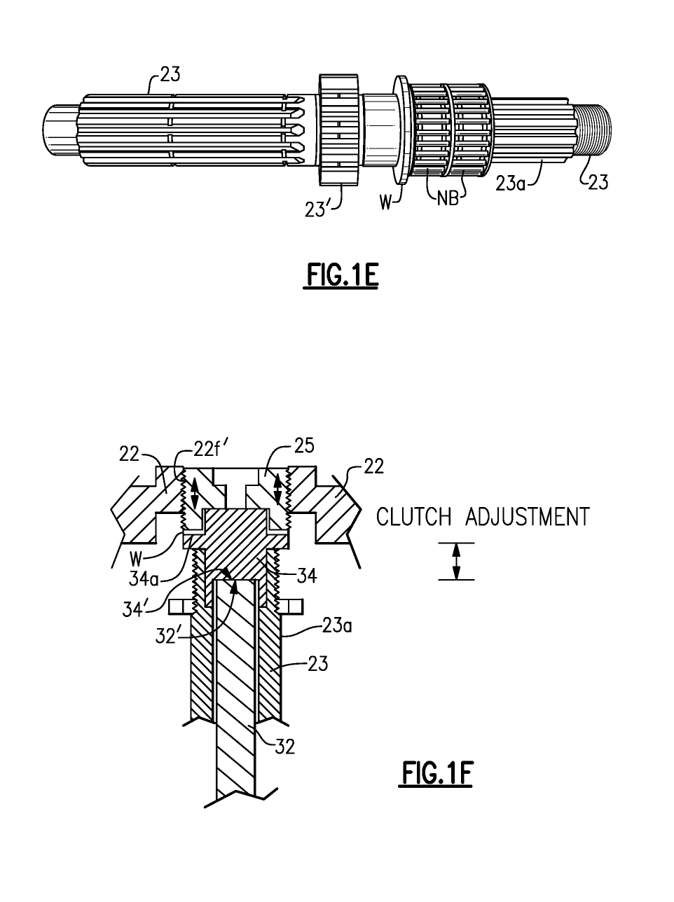

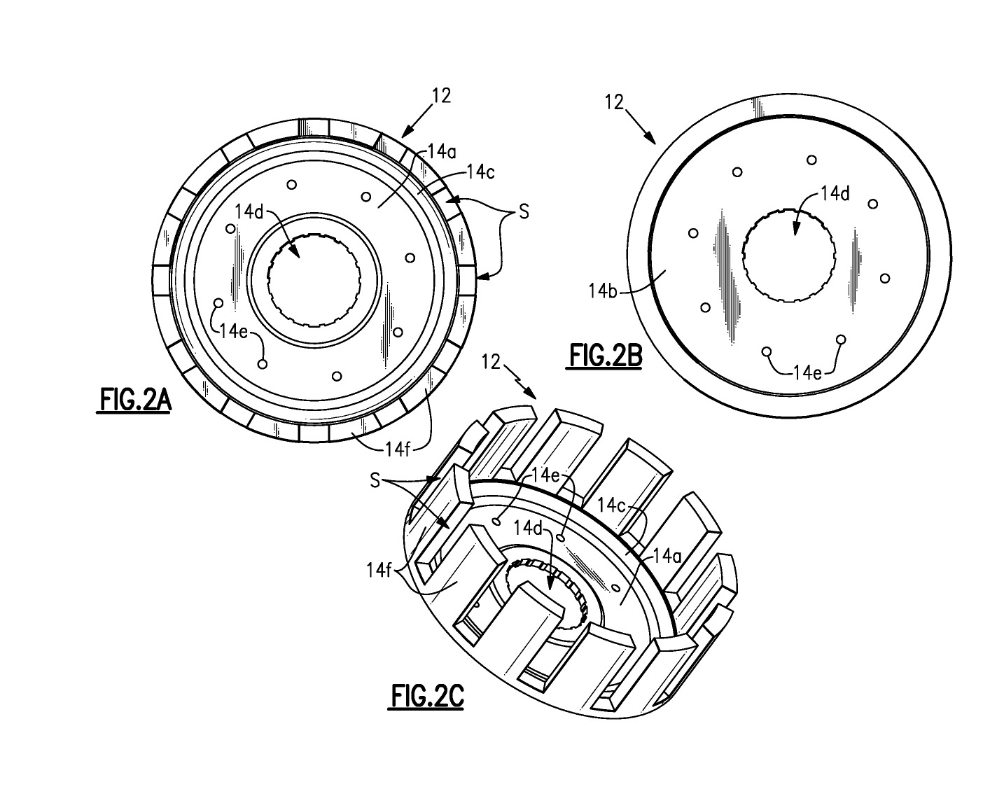

Referring now to FIGS. 1A-F and 2A-C, an embodiment of the invention is seen to include a clutch assembly 10 having a clutch basket 12 including an integral bottom plate 14 having inner and outer plate surfaces 14a 14b, respectively. A plurality of walls 14f which extend in annularly spaced relation about the periphery of bottom plate 14 defining slots “S” between each adjacent pair of walls 14f An inclined surface 14c is formed in bottom plate inner surface 14a and preferably extends the full circumference thereof inwardly of and adjacent to walls 14f A splined through-hole 14d is formed at the center of bottom plate 14. A plurality of threaded holes 14e are formed in annularly spaced relation through bottom plate 14 between center through-hole 14d and inclined surface 14c.

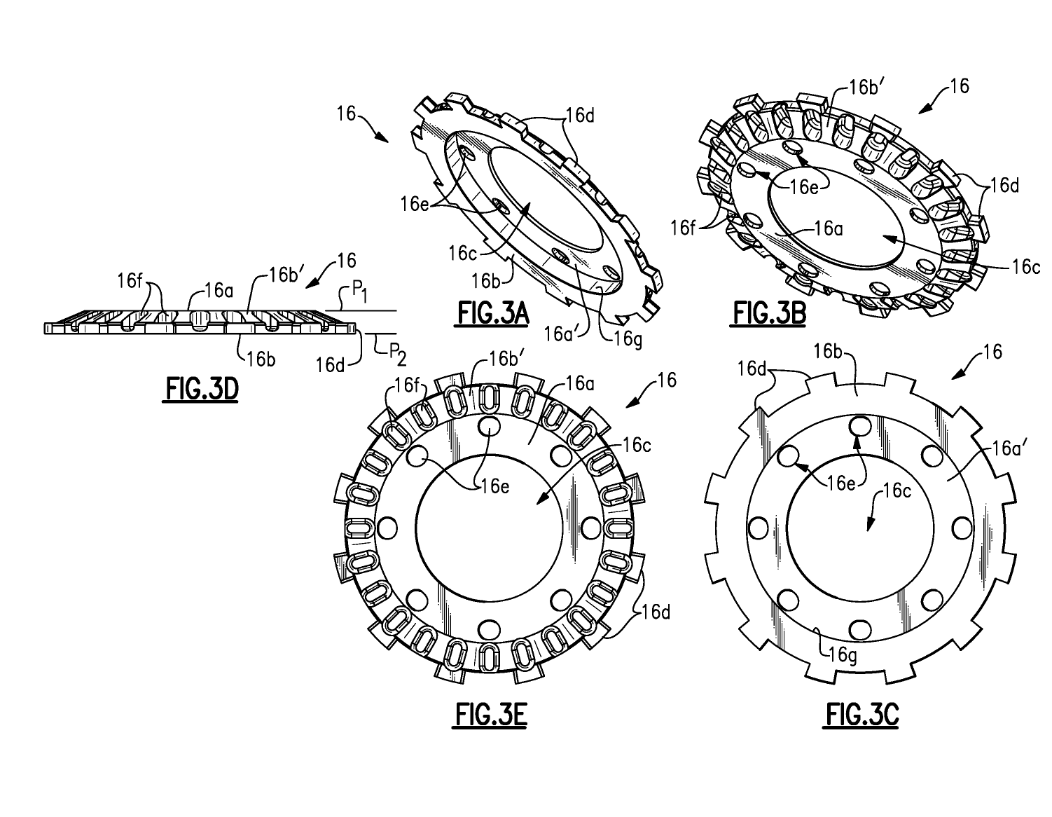

Referring also now to FIGS. 3A-3E, an embodiment of inner pressure plate 16 is seen to include inner wall surface 16a with opposing inner wall surface 16a′ having a center opening 16c extending therethrough, and an outer wall surface 16b with an opposing outer wall surface 16b′ extending radially outwardly of inner wall surfaces 16a, 16a′. A plurality of teeth 16d extend radially outwardly in spaced, annular relation about the periphery of outer wall surfaces 16b, 16b′. A plurality of through holes 16e are formed through inner wall surfaces 16a, 16a′, and a plurality of radially extending, oblong recesses 16f are formed in outer wall surface 16b′. Inner wall surface 16a lies in a plane “P₁” which extends parallel to and spaced from the plane “P₂” in which outer wall surface 16b lies (see FIG. 3D). Outer wall surface 16b′ may extend radially inwardly at an incline to inner wall surface 16a. A stepped wall surface 16g may extend between inner wall surface 16a′ and outer wall surface 16b (see FIGS. 3A and 3C).

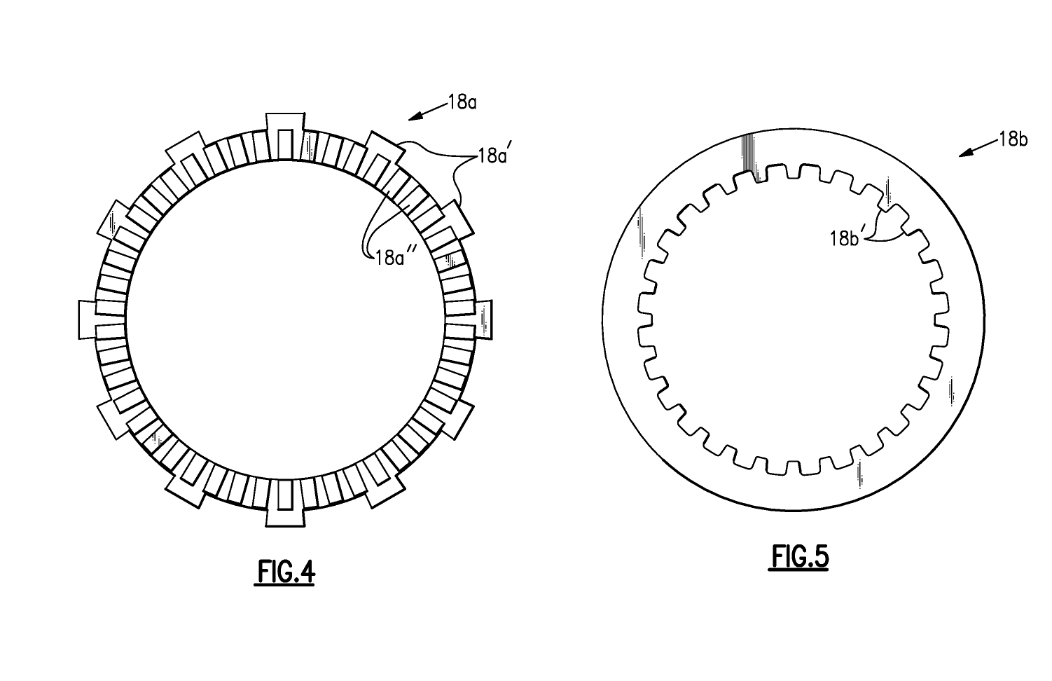

A clutch plate stack 18 is provided having alternating fiber and smooth plates 18a, 18b, respectively (see also FIGS. 4 and 5). Fiber plates 18a include a plurality of teeth 18a′ extending radially outwardly in annularly spaced relation about the perimeter of plate 18a. Fiber plates 18a further include a plurality of annularly spaced friction pads 18a″ on each of the opposing planar surfaces thereof although a single continuous friction pad may also be used on each of the surfaces if desired. Smooth plates 18b include a plurality of radially inwardly extending teeth 18b′ and do not include a friction pad on either of the opposing planar surfaces thereof. Stack 18 preferably begins and ends with a friction plate 18a and in the preferred embodiment includes 8 fiber plates and 7 smooth plates although this may vary depending on the requirements of the specific clutch assembly design.

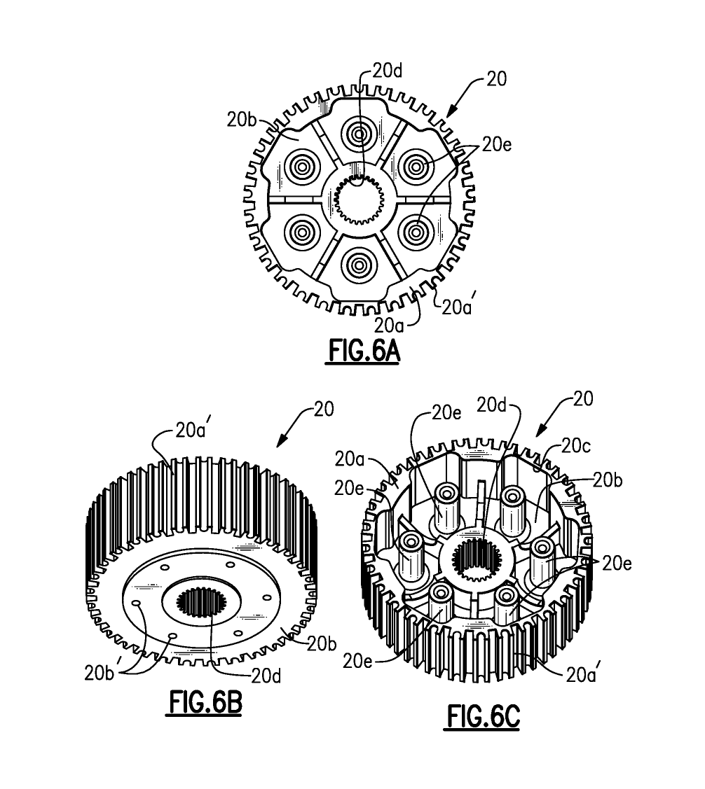

Referring now also to FIGS. 6A-6C, an inner gear 20 is provided having a cylindrical wall 20a extending between a bottom wall 20b and open top 20c. A plurality of longitudinally extending splines 20a′ are formed in the outwardly facing surface of cylindrical wall 20a and are dimensioned to engage smooth plate teeth 18b′ upon mounting clutch plate stack 18 onto inner gear 20 (FIG. 1A). Inner gear 20 further includes a center hole 20d which is also splined. Bottom wall 20b includes a plurality of annularly spaced holes 20b′ which axially align with a like plurality of elongated, internally threaded posts 20e which extend from bottom wall 20b toward open top 20c between cylindrical wall 20a and center hole 20d.

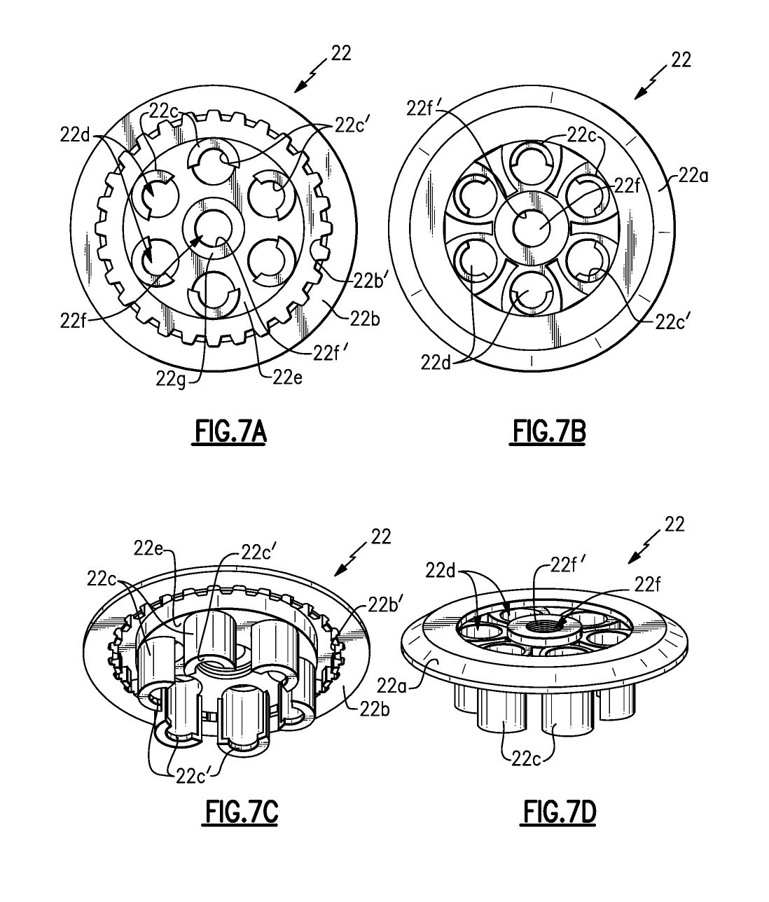

Referring now also to FIGS. 7A-7D, an outer pressure plate 22 is provided having an outer rim 22a with a planar surface 22b defining a center hole 22f A plurality of teeth 22b′ extend radially inwardly of surface 22b and are dimensioned to engage splines 20a′ of inner gear 20. A plurality of semi-circular, longitudinally extending posts 22c are axially aligned with and extend from a like plurality of holes 22d formed in surface 22e. Posts 22c terminate in a ledge 22c′.

As seen best in FIGS. 1A and 1B, clutch basket 12 is attached and rotationally fixed to gear 30 which connects via a chain to the vehicle engine (not shown). As such, the engine, when running, rotates gear 30 and thus also clutch basket 12, even at engine idle. The clutch basket 12 mounts to transmission shaft 23 preferably via bearings such as needle bearings NB as seen in FIGS. 1A and 1E. Clutch basket inclined surface 14c is formed at the perimeter of surface 14a of clutch basket 12 inwardly of spaced walls 14f Inner pressure plate 16 is mounted to clutch basket 12 with pressure plate surface 16a′ facing toward clutch basket surface 14a. A plurality of balls “B” are provided with each ball B captured within a respective recess 16f of inner pressure plate 16 which itself is secured to clutch basket 12 via a plurality of spring-loaded, bottom threaded screws 17 which each pass through a respective pair of aligned holes 14e (threaded) and 16e (non-threaded) in clutch basket 12 and pressure plate 16, respectively. As seen best in FIG. 1D, only the terminal end 17c of each screw 17 is threaded with the section 17d between screw head 17b and threaded end 17c being smooth. As such, each screw 17 is threaded directly into clutch basket opening 14e which thereby fixes the distance between the screw head 17b and clutch basket surface 14a. The diameter of holes 16e in pressure plate 16 is slightly larger than the diameter of screw smooth section 17d passing there-through such that pressure plate 16 may move independently of screws 17 and clutch basket surface 14a.

Each screw spring 17a is pre-loaded between screw head 17b and inner pressure plate surface 16a′, thereby biasing inner pressure plate 16 against clutch basket surface 14a. As seen best in FIG. 1C, balls B are held between recess bottom surface 16f and ramp surface 14c. At higher engine RPMs (e.g., between about 1200 and 1300 RPM), centrifugal force moves balls B radially outwardly within their respective recess. Since pressure plate recess bottom surface 16f is planar and ramp surface 14c is inclined, the centrifugal force is transferred to the balls B exerting a force against plate bottom surface 16f. Upon the centrifugal force exceeding the bias of springs 17a, pressure plate 16 translates axially in a direction away from clutch basket surface 14a (in the direction of arrow A₁ in FIG. 1C). The distance of axial movement of inner pressure plate 16 is equal to the difference in ball B diameter D₁ and the distance D₂ between the outer perimeter of recess surface 14c and recess surface 16f when balls B are at their radially inward-most position (see FIG. 1C). In the absence of manual over-ride of the clutch (as will be discussed below), this distance of axial movement of the pressure plate with respect to the clutch basket is sufficient to compress the clutch plate stack 18 enough to cause the fiber plates 18a to frictionally and rotationally engage the smooth plates 18b and thereby engage the clutch.

Referring still to FIG. 1A, outer pressure plate 22 is mounted to inner gear 20 with posts 22c of the outer pressure plate 22 axially aligned with and extending partially about internally threaded posts 20e of the inner gear 20. A threaded bolt 26 is passed through each pair of aligned posts 22c and 20e with a respective helical spring 31 extending between post 20e and respective post 22c and between post ledge 22c′ and washer 28. Each bolt 26 is threaded into a respective threaded post 20e. In the fully mounted position of outer pressure plate 22 on inner gear 20, washer 28 is seated upon the free end of a respective post 20e.

Surface 22b of outer pressure plate 22 lies immediately adjacent the clutch stack upper-most fiber plate 18a. During high RPMs (e.g., between about 1200 and 1300 RPMs), balls B travel radially outwardly with their respective recesses 16f and cause inner pressure plate 16 to move away from clutch basket 12 and compress clutch stack 12 as described above. As inner pressure plate 16 moves against lower-most fiber plate 18a, the spacing between plates 18a and 18b in the stack closes (referred to as “compressing” the plate stack) with outer pressure plate surface 22b providing a stop against which the adjacent upper-most fiber plate 18a firmly abuts. In this “compressed” clutch stack condition, the fiber plates 18a frictionally and rotationally engage the smooth plates 18b which causes the inner gear 20 to rotate due to the engagement of smooth plate teeth 18′ and inner gear splined surface 20a′. In this “compressed” clutch condition, the clutch is engaged meaning rotational output is provided from clutch basket 12 to inner gear 20 via the compressed clutch stack 18 to the transmission (not shown) via a transmission shaft 23 and gear 23′ with the transmission shaft section 23a splined to inner gear opening 20d.

A rider may manually over-ride the above-described clutch engagement by pulling the clutch lever (not shown) which connects to a push rod 32 extending through the aligned center holes of the clutch assembly components 12, 16, 18, 20 and 22. Pulling the clutch lever causes push rod 32 to move in the axial direction indicated by arrow A₂ in FIG. 1A. This, in turn, causes push rod thrust bearing 34 to also move in the same direction with bearing shoulder 34a abutting outer pressure plate surface 22g (see also FIG. 7A). Push rod 32 and push rod bearing 34 press against surface 22g which causes outer pressure plate 22 to act against the bias of springs 31 and move in axial direction A₂. This action lifts outer pressure plate surface 22b in a direction away from upper-most fiber plate 18a and allows clutch stack 18 to decompress resulting in a disengaged clutch. Releasing the clutch lever moves push rod in the opposite direction releasing the force of bearing 34 against surface 22g. As the clutch lever is released, springs 31 bias outer pressure plate 22 to move back toward inner gear 20. The rider may use tactile feedback from the lever to feel the point on the lever pull/release when the clutch switches between disengagement and engagement. Of course at high RPMs, the balls force the clutch into engagement unless the rider over-rides the clutch engagement by pulling the clutch lever as described above. Therefore, if desired, a rider may keep the bike in place, engage the clutch lever and throttle the engine to a higher than about 1300 RPM without engaging the clutch. As such, a rider may choose at which RPM to begin releasing the clutch lever to engage the clutch. Furthermore, if a rider is riding rough and hilly dirt bike trails, he/she may use the clutch lever to disengage the clutch momentarily to prevent wheel spin in the dirt during a run on the trail.

It is well known to dirt bike racers that the clutch can come out of desired engagement settings. When this happens, the rider must stop the bike and adjust the clutch. The time it takes to adjust the clutch negatively affects the rider's ride time and is tried to be kept to a minimum. The present invention provides in another aspect the ability to adjust the clutch in a very quick and simple manner.

Referring again to FIGS. 1A-1F, a clutch cover 24 is provided having a plurality of mounting projections 24c each having respective hole through which a respective bolt may pass (not shown) to secure the clutch assembly 10 to a vehicle. Cover 24 is seen to include a cap plate 24a that is removably attached to an access hole 24b formed in the cover plate 24. When removed, a tool may be passed through hole 24b to reach clutch adjustment screw 25 which is has an outer threaded surface 25′ which threads to the outer pressure plate at plate threaded surface 22f′ which defines plate hole 22f A rider may quickly adjust the clutch push rod position by turning clutch adjustment screw 25 either clockwise or counterclockwise depending on the clutch action they want. When turned in plate hole 22f and moved in the direction toward the push rod 32, the screw 25 will also move against bearing surface 34a via thrust washer W which will both likewise travel toward push rod 32. Thus, push rod end 32′ will have less distance to travel to engage element 34 and less clutch lever will be required to manually override the clutch. Conversely, backing screw 25 off in the opposite direction (toward cover 24) will increase the distance between push rod end 32′ and element 34. The driver thus will need to pull the clutch lever a bit more to manually override the clutch. It will thus be appreciated that a driver may very quickly adjust the clutch by simply removing the cap plate 24a passing a tool through the plate hole 24b to engage and adjust clutch adjustment screw 25 as desired. Once torqued the desired amount the rider replaces cap plate 24a and is ready to ride. The total time to adjust the clutch adjustment screw as described above is in the range of seconds rather than minutes which is an incredible advantage over other riders not having the benefits the present invention provides.

While this method and apparatus has been shown and described with reference to certain preferred embodiments thereof, it will be understood by those skilled in the art that various changes in form and details may be made therein without departing from the spirit and scope of the invention as defined in the following claims.

What is claimed is:

1. A clutch assembly for operably attaching to a motor and transmission shaft of a wheeled vehicle, said clutch assembly comprising:
a) a clutch basket having a bottom wall having a ramped surface and a plurality of radially spaced walls extending from said bottom wall adjacent the periphery, said clutch basket rotating upon the running of the motor ;
b) an inner pressure plate positioned adjacent and biased against said clutch bottom wall;
c) a plurality of ball bearings positioned between said ramped surface of said clutch basket bottom wall and said inner pressure plate;
d) an inner gear having an outer surface and a center opening adapted to be rotationally fixed to a transmission shaft;
e) a clutch plate stack having a plurality of alternating fiber and smooth plates with each of said fiber and smooth plates having teeth, said clutch plate stack having a beginning plate and an ending plate at the opposite ends said stack, said beginning plate positioned adjacent said inner pressure plate with the teeth of one of said fiber or smooth plates extending between and thereby rotationally fixed to said radially spaced walls of said clutch basket, and the teeth of the other of said fiber or smooth plates engaging and thereby rotationally fixed to said outer surface of said inner gear, said clutch plate stack being movable between compressed and uncompressed conditions wherein when in said uncompressed condition, said fiber plates and said smooth plates are not rotationally fixed together and when in said compressed condition, said fiber plates and smooth plates are rotationally fixed together;
f) an outer pressure plate positioned and biased against said ending plate of said clutch plate stack; and
g) a selectively, manually operable push rod connected to said outer pressure plate, wherein manual operation of said push rod creates a force against the bias direction of said outer pressure plate;
wherein rotation of said clutch basket creates a centrifugal force causing said ball bearings to move radially outwardly along said ramped surface causing said ball bearings to apply a force in a direction against the bias direction of said inner pressure plate allowing said clutch plate stack to move to said compressed condition with selective operation of said push rod causing said clutch plate stack to move to said uncompressed condition.

2. A clutch assembly according to claim 1, further comprising:
a) a clutch cover having an opening wherethrough a tool may be passed to adjust the position of said push rod relative to said outer pressure plate.
